(19) United States
(12) Patent Application Publication
(10) Pub. No.: US 2011/0132296 A1
(43) Pub. Date: Jun. 9, 2011

(54) Engine Arrangement with Integrated Exhaust Manifold

(75) Inventor: Kai Kuhlbach, Bergisch Gladbach (DE)

(73) Assignee: FORD GLOBAL TECHNOLOGIES, LLC, Dearborn, MI (US)

(21) Appl. No.: 13/058,175

(22) PCT Filed: Aug. 5, 2009
(86) PCT No.: PCT/EP2009/060149

§ 371 Date: Feb. 14, 2011

(30) Foreign Application Priority Data
Aug. 8, 2008 (DE) 10 2008 036 945.4

(51) Int. Cl. F02F 1/36

(52) U.S. Cl. 123/41.82 R

(57) ABSTRACT

An integration of the exhaust manifold into the cylinder head, initially for turbo application, is proposed, and an associated cooling concept is provided. This serves to achieve significant improvements in characteristic features whilst at the same time affording significantly reduced system costs. The advantages of this application are demonstrated taking a four-cylinder petrol engine constructed with direct fuel injection and turbo-charging as an example. Particularly worth emphasizing are the reduced fuel consumption in the ranges at or close to full load, reduced CO₂ emissions in the European Driving Cycle, more rapid catalytic converter start-up, and improved engine warm-up and heating of the vehicle interior, together with the significant reduction in complexity through elimination of the conventional exhaust manifold and the associated significant weight and cost reductions.

### FIELD

The invention relates to an engine arrangement according to the preamble of claim 1 and to internal combustion engines according to the preambles of claims 12 and 13.

### BACKGROUND SUMMARY

Downsizing in conjunction with direct injection and supercharging in spark-ignition engines is seen as a sensible solution in making a substantial contribution to the achievement of the necessary reduction of CO₂ emissions in coming years. In order to achieve widespread use in fleets, the spark-ignition-DI-downsizing drive system must be carefully optimized in terms of sustainability (for the customer and for the fleet), handling characteristics and costs.

The European Commission has CO₂ emission targets of 130 g/km planned for the automobile fleet consumption for the period of 2012. Meeting these future limits is a major consideration for the planning of the drive portfolio of vehicle manufacturers.

On the basis of the existing technology of the spark-ignition engines (naturally aspirated engines with inlet manifold injection and variable valve timings and/or exhaust gas recirculation) it is possible to exploit further potential for reduced CO₂ emissions through a moderate investment in technology in the field of friction reduction and heat management.

For small and medium-sized vehicles on the European market, achievement of the aforementioned CO₂ limit is possible through the use of new combustion methods in spark-ignition engines (stratification concepts, homogeneous self-ignition) or downsizing concepts as the most important step. For a further reduction of CO₂ emissions a downsizing concept may also be combined with further combustion method measures.

The fulfillment of various customer expectations, particularly with regard to fuel consumption in actual day-to-day use, driving enjoyment, low-noise levels, and affordable costs, are crucial for the market penetration of downsizing concepts.

In particular, the greater use of the supercharged range in these concepts demands special attention to the avoidance of fuel enrichment as a means of safeguarding components, and to securing good dynamic engine response. An avoidance of fuel enrichment can be achieved within certain limits through the use of especially temperature-resistant materials, although this leads to increased manufacturing costs. In addition, getting the necessary heat output from small, highly efficient engines is becoming increasingly difficult.

The object of the invention is to improve an engine arrangement of internal combustion engines of the type specified in the introduction so that even in the supercharged range, fuel enrichment as a means of safeguarding components can be dispensed with and/or the use of fewer temperature-resistant materials in the exhaust path becomes possible, whilst at the same time seeking to improve the start-up performance of an exhaust treatment arrangement.

The stated object is achieved by means of an engine arrangement having the features of claim 1 and by means of internal combustion engines having the features of claims 12 and 13.

Advantageous developments of the invention are set forth in the dependent claims.

In the course of the invention it was established that an exhaust manifold integrated into the cylinder head is not only particularly compact and sparing in the use of materials, but given a sufficiently efficient design of the liquid cooling in the cylinder head, also allows the exhaust gas to be cooled effectively so that the exhaust gas temperature at the outlet from the cylinder head is limited within all engine operating conditions to a maximum value, which is significantly lower than the maximum exhaust gas temperatures occurring in comparable internal combustion engines with conventional exhaust manifolds. This means that on the one hand, fewer temperature-resistant materials can be used for the rest of the exhaust system, particularly for the turbine and the turbine housing of a turbocharger adjoining the exhaust manifold, and/or that artificial exhaust gas temperature reductions through mixture enrichment, which would otherwise be necessary under high loads, can be dispensed with. It is therefore possible—for specific vehicle target groups—either to reduce the manufacturing costs or to improve the fuel consumption values, or to secure an advantage with regard to both of these aspects.

A correspondingly efficient exhaust gas cooling in the cylinder head, however, requires a very precise design of the coolant passages, in order to avoid localized overheating in the cylinder head, which might rapidly lead to destruction in the case of the aluminum alloys used for the cylinder heads. For this reason, extensive computer-based optimization and simulation processes are required in order to ensure the thermal and mechanical durability of such a cylinder head.

In an especially efficient exhaust gas cooling system, however, there is the obvious concern that the time taken for a catalytic converter or another exhaust gas treatment arrangement to warm up after a cold start could be prolonged, which in turn would necessitate additional fuel-consuming countermeasures. Surprisingly, it has emerged, however, that the start-up performance of an exhaust gas treatment arrangement is on the contrary improved even further by an integral exhaust manifold according to the invention. This is probably ultimately due to the fact that an integral exhaust manifold, by virtue of its more compact construction, has smaller exhaust passage internal areas than a conventional external exhaust manifold, since the individual exhaust passages in the integral exhaust manifold combine sooner to form one overall exhaust line. For the start-up performance of a catalytic converter, however, the total area of the exhaust passages up to the exhaust gas treatment arrangement has emerged as an important parameter. For the warm-up properties of the exhaust gas shortly after engine starting it still virtually does not matter whether these exhaust passages are water-cooled or merely air-cooled, since the temperature gradient between the exhaust line wall and the exhaust gas during cold-starting is in any event very large.

Furthermore the shortest possible exhaust gas paths up to a turbocharger improve the engine response in transient load cycles.

In the context of the invention, therefore, proportionally large areas of the exhaust paths from the valve seat of the exhaust valves are liquid-cooled. In particular it is proposed that the ratio of the total area of the internal walls of the liquid-cooled exhaust gas paths in the cylinder head, measured from the exhaust ports to the outlet of the overall exhaust line from the cylinder head, be more than 50%, preferably more than 65%, more preferably more than 80%, and most preferably more than 85%, of the total area of the internal walls of the exhaust paths, measured from the exhaust ports to a reference element of the first exhaust-flow device outside the cylinder head.

The first exhaust-flow device is preferably an exhaust-driven turbocharger, and the reference element for determining the proportional areas is the start of a spiral housing or a volute of the turbine of the turbocharger. In the context of the present invention such an exhaust-driven turbocharger is proposed not only for diesel engines, but in particular also for spark-ignition engines. An exhaust treatment device (catalytic converter, NOx-trap, etc.) generally adjoins this exhaust-driven turbocharger.

On vehicles without supercharging the first exhaust-flow device may also be an exhaust emission control device, and the reference element is then the start of an exhaust emission control substrate on the engine side.

The exhaust heat dissipation capacity of the liquid cooling in the cylinder head is preferably designed in such a way that within all engine operating conditions it is possible to limit the temperature of the exhaust gas at the outlet of the overall exhaust line from the cylinder head to a predefined temperature value, so that the downstream devices in the exhaust system do not have to be of such temperature-resistant design and/or so that enrichments of the mixture in order to reduce the exhaust gas temperature in high load ranges can be dispensed with, the total design area of the liquid-cooled internal walls of the exhaust paths being so small that a rapid start-up of an exhaust gas treatment arrangement during cold-starting of the internal combustion engine is achieved preferably without additional fuel-consuming measures to improve the start-up performance.

In order to preclude any damage to the cylinder head generally composed of an aluminum alloy, the liquid cooling of the exhaust paths in the cylinder head is furthermore preferably designed in such a way that the temperature of the walls of the exhaust paths in the cylinder head under stationary full-load conditions does not exceed a limit of 250° C., preferably 180° C., without any need for enrichment of the mixture in order meet this limit.

In order to ensure such adequate cooling, coolant passages, which preferably enclose the full circumference of the overall exhaust line between the junction and the outlet of the overall exhaust line from the cylinder head, are preferably provided in the cylinder head.

If this is not sufficient, a supplementary liquid cooling may also be provided in the exhaust paths outside the cylinder head. For this purpose the overall exhaust line between its outlet from the cylinder head and the reference element of the first exhaust-flow device may be liquid-cooled in its entirety or in partial areas thereof. Alternatively or in addition the first exhaust-flow device—in particular a turbocharger—may also be liquid-cooled in its entirety or in partial areas thereof.

In order to ensure that a start-up performance of an exhaust gas treatment arrangement is as rapid as possible, it proves advantageous if the first exhaust-flow device in the exhaust path adjoins the cylinder head as directly as possible. If this first arrangement is a turbocharger, an exhaust gas treatment arrangement is preferably arranged as immediately downstream of the turbocharger as possible.

The exhaust manifold geometry is preferably designed in such a way that the total area of the internal walls of the liquid-cooled exhaust paths in the cylinder head in a four-cylinder spark-ignition engine having two exhaust ports per cylinder and a rated power output of at least 100 kW with a mean diameter of the exhaust paths in the range from 25 to 30 mm, is less than 70.000 mm², preferably less than 60.000 mm², simulations having shown that a possible optimum area lies in the region of approximately 50.000 mm². These values naturally also depend on the passage diameter, it having emerged that a smaller passage diameter leads to greater heat dissipation. In particular, in the aforementioned operating ranges the following approximate function applies for the dissipated heat flow \dot{Q} in respect of the passage diameter D:

\dot{Q}˜D^{-0.8}

In an internal combustion engine which is designed, in particular, for an engine arrangement according to the invention, the liquid cooling of the exhaust paths in the cylinder head is preferably designed in such a way that under stationary full-load conditions the exhaust gas temperature at the outlet from the cylinder head does not exceed a predefined limit of 1050° C., 970° C. or 850° C., without any need for enrichment of the mixture in order meet this limit. Such a limit means that an exhaust-driven turbocharger, particularly one intended for a spark-ignition engine, can be made from less expensive materials. For a maximum temperature of 1050° C.—the temperature limit conventionally used but generally ensured in the full-load range by an enrichment of the mixture—relatively cost-intensive materials such as austenitic cast steel with a nickel content of up to 37% have to be used for both components, the exhaust manifold and the turbine. For maximum temperatures of 980° C. to 1030° C., on the other hand, cast steel with a lower nickel content of 0 to 30% can be used. For even lower temperature limits of 970° C. or 950° C. more reasonably-priced materials such as SiMo-grey cast iron (temperature limit up to 950° C.) may be used.

It is characteristic of the exhaust gas cooling in the context of the present invention that in the higher load ranges a higher proportion of the combustion energy relative to the mechanical power output is dissipated into the coolant than is the case in known exhaust manifold concepts. In particular the liquid cooling of the exhaust paths is designed in such a way that in stationary partial and full-load operation of the internal combustion engine above 80% of the rated power output and in excess of an engine speed of 4400 min⁻¹ with a stoichiometric mixture, the ratio of the total heat output given off to the coolant by the internal combustion engine as a proportion of the delivered mechanical power output is not less than 50%, more preferably not less than 55%. This has the additional advantage of allowing a rapid warming-up of the engine block (reduction in friction) and an efficient heating of the passenger compartment.

The invention will be explained in more detail below by way of example and with reference to the drawings, in which:

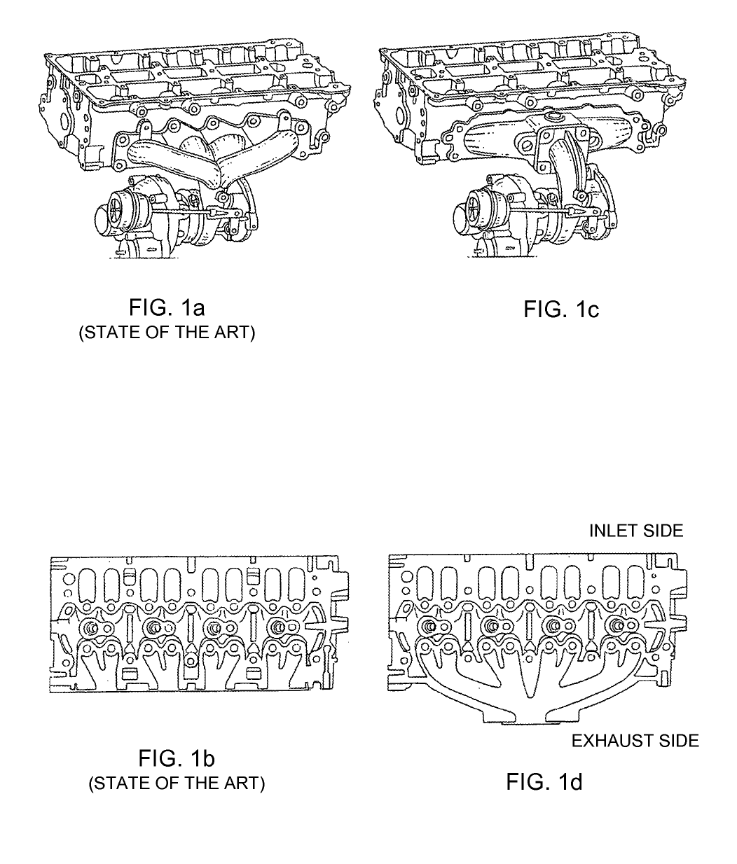

FIG. 1a-d shows cylinder heads with an adjoining turbocharger according to the state of the art with separate exhaust manifold (FIG. 1a,b) and with integral exhaust manifold according to the invention (FIG. 1c, 1d);

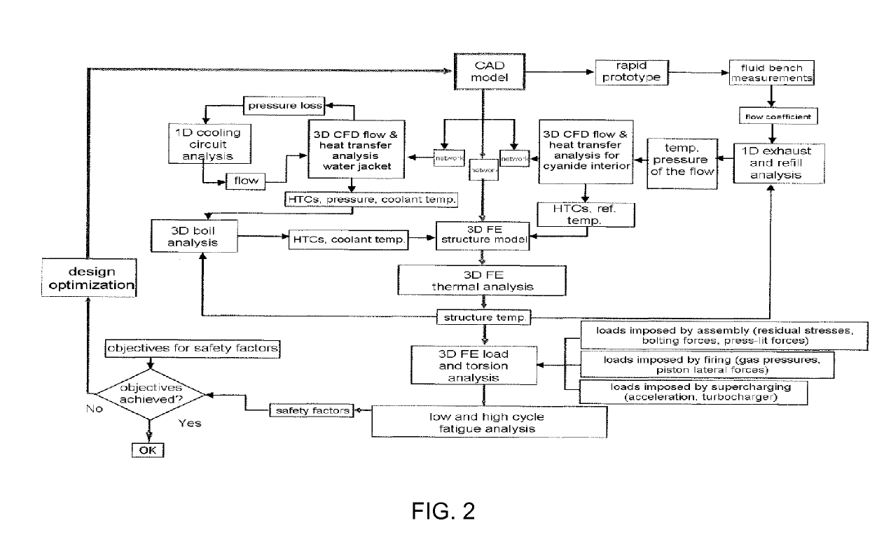

FIG. 2 shows a flow chart of the optimization process for an engine arrangement according to the invention;

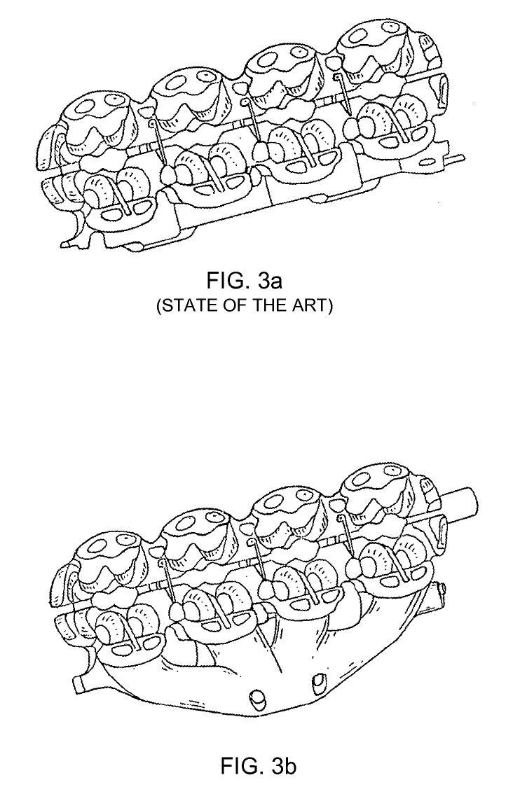

FIG. 3a, b shows a flow speed distribution of the coolant in a standard cylinder head (FIG. 3a) compared to a cylinder head according to the invention (FIG. 3b) at an engine speed of 5500 min⁻¹ and with fully opened coolant thermostat;

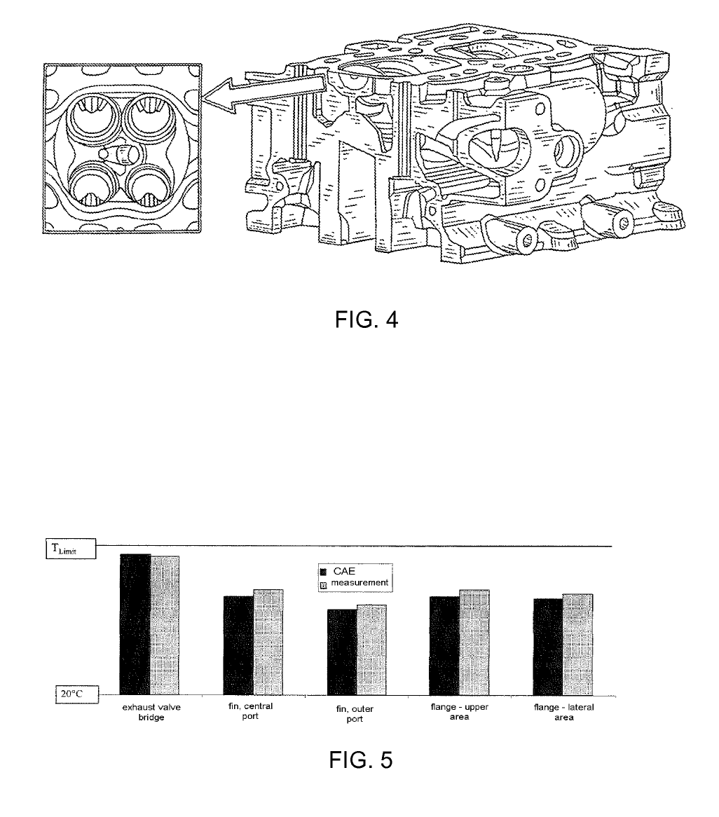

FIG. 4 shows a temperature distribution of the cylinder head according to the invention at an engine speed of 5500 min⁻¹, full load and with fully opened coolant thermostat;

FIG. 5 shows a comparison of computed to measured cylinder head metal temperatures for verifying the quality of simulation at an engine speed of 5500 min⁻¹, full load and with fully opened coolant thermostat;

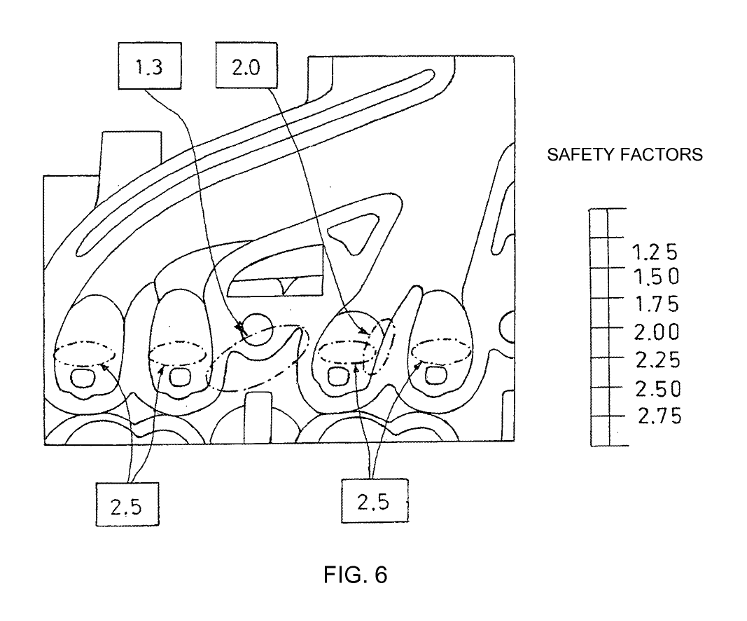

FIG. 6 shows a representation of the high cycle fatigue safety factors calculated for an exhaust manifold according to the invention relative to the service life limit;

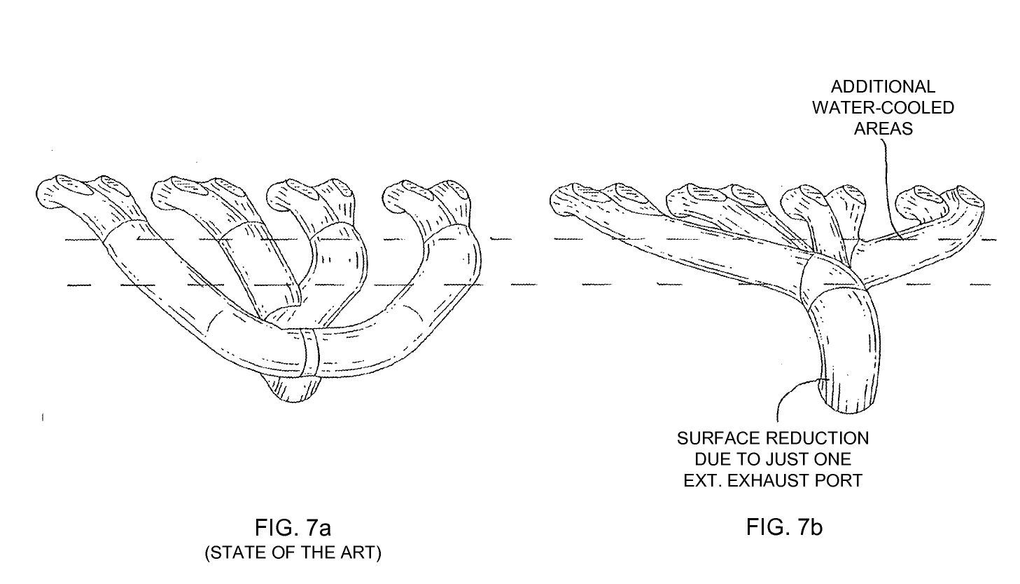

FIG. 7a, b shows a comparison of an exhaust manifold according to the state of the art (FIG. 7a) with an integral exhaust manifold according to the invention (FIG. 7b).

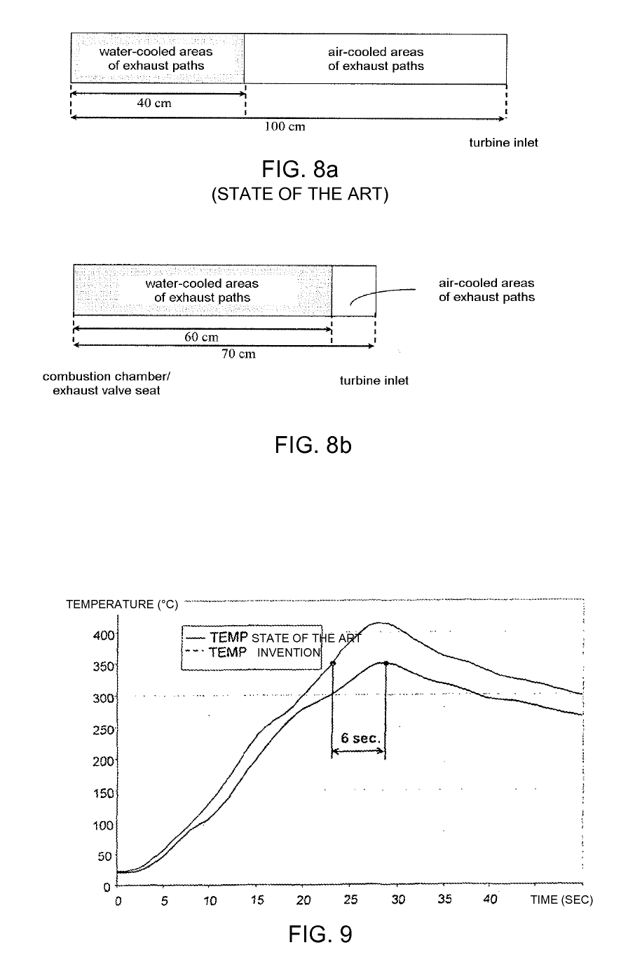

FIG. 8a, b shows schematic diagrams comparing the exhaust path surfaces or equivalent exhaust path lengths up to the turbine of the turbocharger for an equivalent exhaust line with a diameter of 30 mm;

FIG. 9 shows a diagram comparing the exhaust gas temperature upstream of the turbine of the turbocharger for a known exhaust manifold and an integral exhaust manifold according to the invention after cold-starting at an ambient temperature of 21° C.;

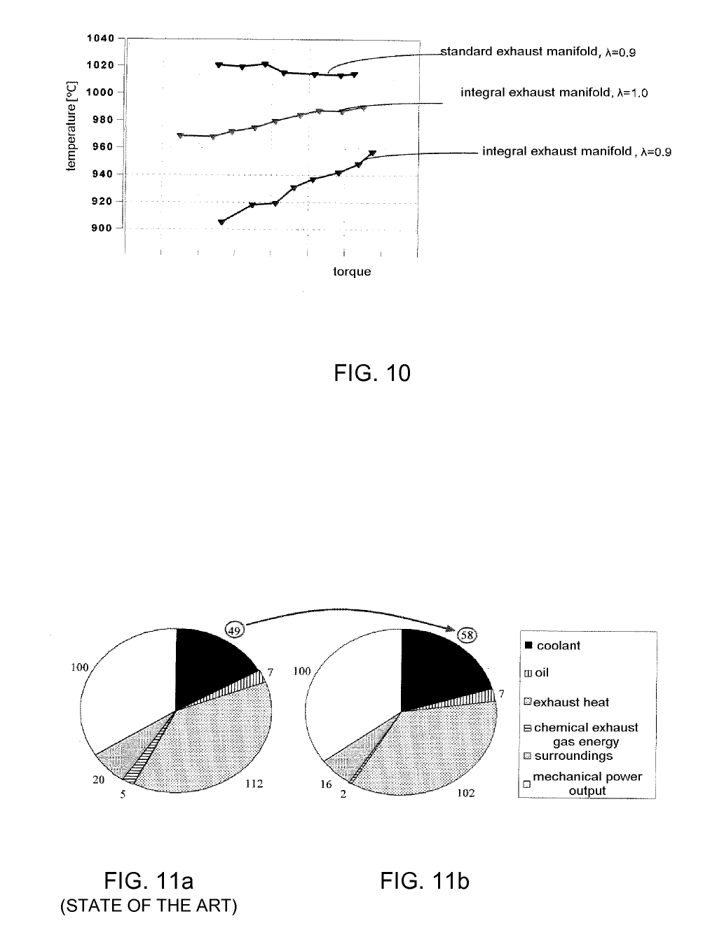

FIG. 10 shows a comparison of the exhaust gas temperatures upstream of the turbine of a turbo charger under high loads;

FIG. 11a, b shows a diagram comparing the energy balances of an internal combustion engine according to the state of the art (FIG. 11a) with an internal combustion engine designed according to the invention (FIG. 11b) in the partial load range;

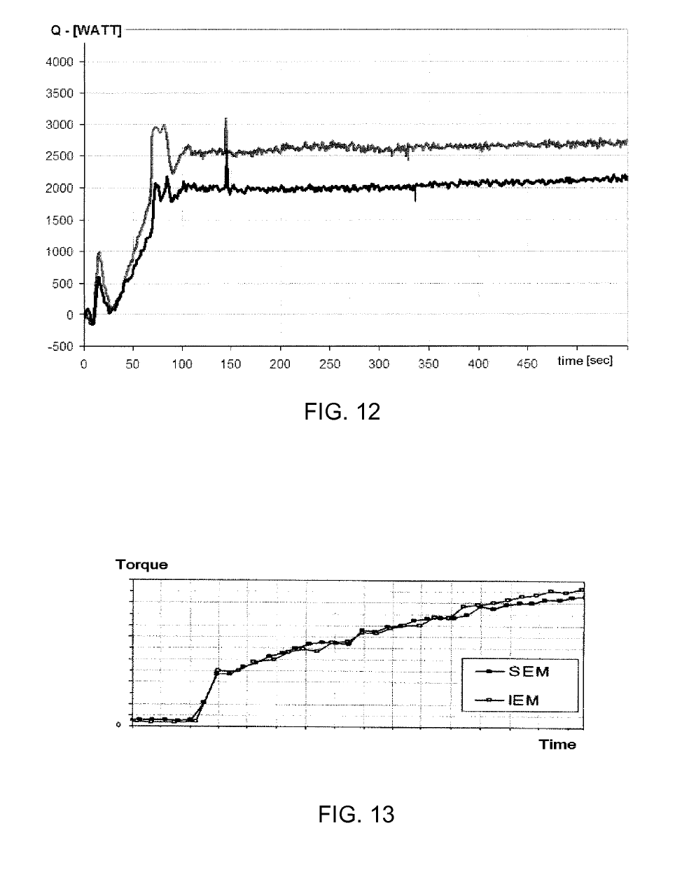

FIG. 12 shows a diagram comparing the heat flow into the coolant during the warm-up phase at an engine speed of 1500 min⁻¹ and a BMEP of 1 bar (mean values of the urban driving part of the NEDC driving cycle);

FIG. 13 shows a diagram comparing the engine response in a transient load cycle of 1 bar BMEP at 1500 min⁻¹;

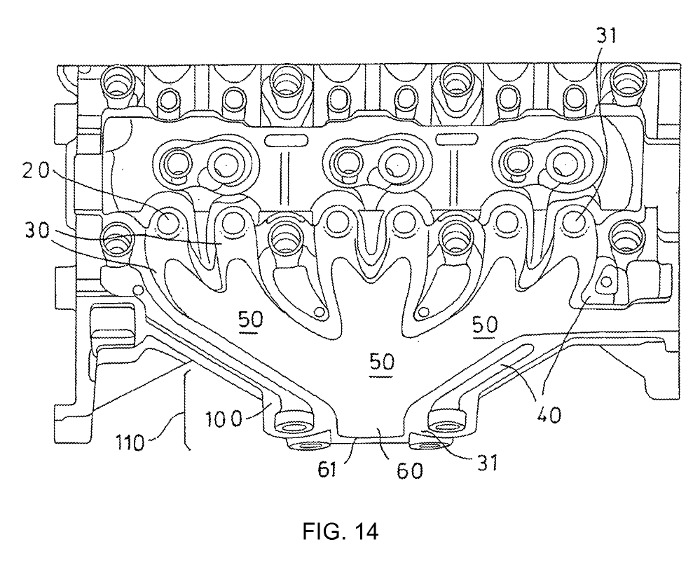

FIG. 14 shows a perspective view of a cylinder head according to the invention with an integral exhaust manifold, shown partially in section;

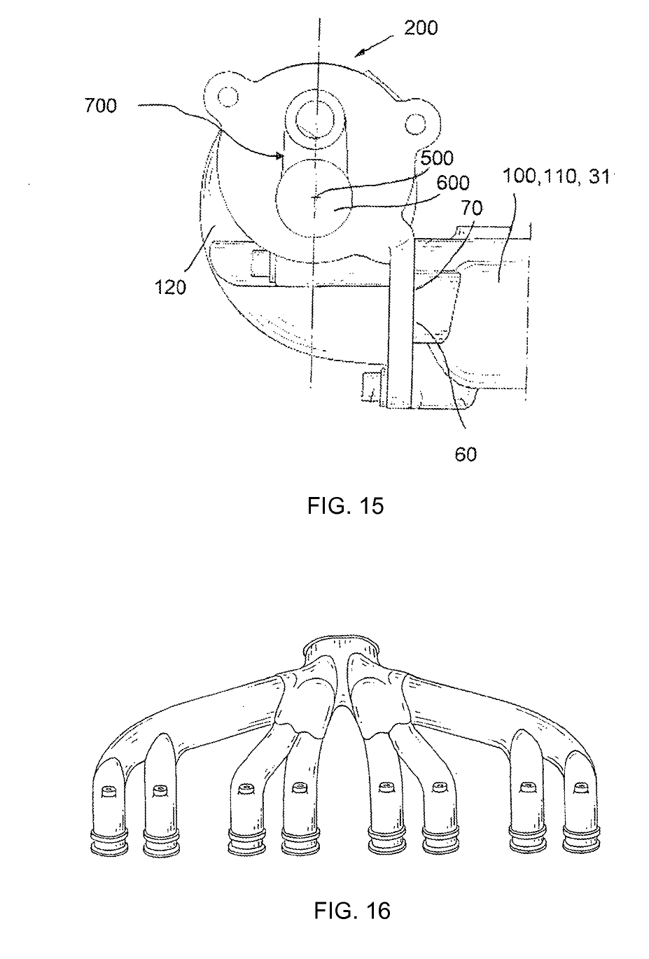

FIG. 15 shows a representation of a turbocharger adjoining the cylinder head according to the invention; and

FIG. 16 shows a quantitative representation of the local distribution of the heat transfer coefficient.

The engine arrangement according to the invention with an internal combustion engine comprises a cylinder block having at least two cylinders, each cylinder, as shown in FIG. 14, comprising at least one exhaust port 20 selectively closeable by an exhaust valve for removing the exhaust gases. The exhaust gases from the individual exhaust ports 20 are led through exhaust lines 30, which unite predominantly inside the cylinder head 100 to form preferably one overall exhaust line 60, and the exhaust paths provided in the cylinder head 100 are liquid-cooled by coolant passages 40 provided in proximity to these exhaust paths. The integral area 110 protruding from the cylinder head is likewise liquid-cooled and primarily serves for the weight-saving design of a connection face for a first exhaust-flow device. For enhanced liquid cooling the area 110 may also protrude less markedly and in particular may be formed approximately in alignment with the cylinder head outside wall. Outside the cylinder head 100 the overall exhaust line 60 merges into a first exhaust-flow device. For optimized, rapid warming-up of the first exhaust-flow device, which here is shown exemplified by a turbocharger, and in conjunction with this for reduction of its maximum operating temperature, the ratio of the total area of the internal walls 50 of the liquid-cooled exhaust gas paths in the cylinder head 100, measured from the exhaust ports 20 to the outlet 61 of the preferably single overall exhaust line 60 from the cylinder head 100, is designed for a value of more than 50%, preferably more than 65%, more preferably more than 80%, and most preferably more than 85% of the total area of the internal walls of the exhaust paths 50, measured from the exhaust ports 20 to a reference element of the first exhaust-flow device outside the cylinder head. The internal walls 50 of the liquid-cooled exhaust paths in the cylinder head 100, from the exhaust ports 20 to the outlet 61 of the preferably single overall exhaust line 60 from the cylinder head 100, are referred to as an integral exhaust manifold 31.

As shown in FIG. 15, the cylinder head 100 has an integral exhaust manifold 31 for removing exhaust gases via an overall exhaust line 60 emerging from the cylinder head 100. The turbine 200 has an inlet area 70 for admission of the exhaust gases, the inlet area 70 directly adjoining the overall exhaust line 60 or the end 61 thereof.

From the inlet area 70 the exhaust gas is fed via the spiral housing 120 to the rotor 600 of the turbine 200 arranged downstream and supported so that it can rotate about an axis of rotation 500. The turbine 200 is here exemplified by a radial-flow turbine having a volute 700.

In the case of the turbocharger shown by way of example, the reference element for determining this area ratio is the starting area of the spiral housing 120, that is to say the contour, which represents the transition of the inlet area 70 into the spiral housing.

### System Description

At the heart of the construction is the complete integration of the normally separately formed exhaust manifold into the aluminum cylinder head, in particular for the turbocharged spark-ignition engine. After emerging from the cylinder head there remains a single pipe connection to the turbine, the connection of which can moreover be of even more compact design if the boundary design conditions so allow, see FIG. 1.

In this instance the entire cylinder head became only 32 mm wider than the standard cylinder head and only 0.2 kg heavier. The latter is obviously due to the significantly smaller sealing face, which typically has to be structurally reinforced.

In order to comply with the required and maximum admissible component and material temperatures, a whole new cooling concept was implemented in the cylinder head. This was first designed in virtual form and optimized, fully calculated in terms of the structure and fluid mechanics and in the ensuing development phase was validated in hardware on the test bench (see the next section).

### 1 Service Life

### 1.1 Method

The integration of the exhaust system leads to an additional heat input into the cylinder head and thereby to increased thermo-mechanical loads, which represent a particular challenge for the engine. The cylinder head construction, like other structural components, was assessed, taking the modified loads into account, by numerical simulation on the basis of network, finite element method (FEM), and computed fluid dynamic (CFD) methods. The sequence of operations represented in FIG. 2 contains the simulations performed and their interactions.

### 1.2 Flow Calculations

CFD methods are now routinely used during the development process in order to calculate the flow and pressure distribution in the water jacket of the cylinder block and cylinder head. In the initial investigations, pictured in FIG. 3, calculations were performed using material data constants of the coolant, so that owing to the incompressibility and the thermal decoupling between flow and temperature field, the law of energy conservation was not needed in or to determine the flow field. In order to achieve adequate cooling of the extended exhaust passages, the hole pattern of the cylinder head gasket was modified. This meant, on the one hand, that the pressure loss via the engine could be reduced, thereby reducing the volumetric flow in the overall system. On the other hand a proportionally increased cross flow meant that the areas in proximity to the combustion chamber, such as the exhaust valve bridges or the thermally and mechanically highly stressed flange area, for example, could be adequately cooled. Despite modification of the cooling concept, it was also possible in the variant with integral exhaust manifold to achieve a sufficiently high flow level in all critical areas of the cylinder block, without modifying the design or the rotational speed of the pump.

In engines with a high power density it is necessary, in calculating the heat transfer by the coolant, to take account not only of the forced convection but also of other phenomena. Boiling gives rise to local vaporization of the coolant, with the result that the heat of vaporization needed for the phase transition is also abstracted from the surface. There is thereby a considerable increase in the heat dissipation by the coolant. There are various known physical statements for taking account of the boiling effect. Common to all of them in practical application is that the heat transfer coefficient calculated by the CFD method is additively superimposed on the boiling heat transfer coefficient as soon as the boiling temperature is locally exceeded. The magnitude of the local static pressure is responsible for the level of the boiling temperature. With large heat inputs and low coolant speeds, large coolant temperature gradients can occur locally in areas of the engine close to the wall. Owing to the temperature-dependent material and flow characteristics of the fluid and the resulting inertial forces, a flow field is induced, which can have a considerable influence on the speed and heat transfer coefficient distribution. The phenomena discussed here can in this case be mapped by an iterative process between CFD and FE code.

In order to calculate the temperature distribution in the cylinder head, it is essential to know the heat input from the gas. The flow in the combustion chamber and in inlet and exhaust ports was calculated by three-dimensional simulations, and the gas boundary conditions for a stationary calculation are determined by suitable averaging with the equations for the local heat transfer coefficients and reference gas temperatures averaged over time:

$$\overline{α} = \frac{1}{720 ° KW} {\int }_{φ = 0}^{720 ° KW} α ( φ ) d φ and$$

$$\overline{T} = \frac{1}{720 ° KW \cdot \overline{α}} {\int }_{φ = 0}^{720 ° KW} α ( φ ) \cdot T ( φ ) d φ$$

### 1.3 Temperature Calculations

Since heat is introduced into the structure from the combustion chamber and from the passages on the one hand, and gets into the cylinder head via the valves and the valve seat rings on the other, the maximum temperatures occur in the area of the valve bridges, as shown in FIG. 4. In critical operating ranges, however, such as at rated speed and full load, for example, the temperature limits for the AlSi-aluminum alloy used are not exceeded. Due to the high mechanical loading the rigidity in the area of the turbocharger flange should be high and the temperature level should be low.

### 1.4 Model Verification

In order to verify the calculations discussed and to increase the confidence in the following service life calculations, a cylinder head with integral exhaust gas system was fitted with thermocouples. As shown in FIG. 5, the maximum difference between the predicted and the measured temperature is in the order of magnitude of 10° C. and is satisfactory for a model which, with regard to the heat transfers by the gas, was not calibrated for this special application.

Both the numerical and the experimental analyses resulted in an additional heat input—varying as a function of the operating range—into the coolant circuit of up to 20% as a result of the integration of the exhaust gas system into the cylinder head. In order to keep the coolant temperature at the same level in thermally critical operating ranges, it must be possible to dissipate this heat by enlarging the vehicle radiator.

### 1.5 Material Fatigue Calculations

After calculating the wall and surface temperatures, an important next step is to register the thermo-mechanical loads and to predict the resulting component service life. Modern engine architectures achieve an ever-greater specific power output and in their development phase can no longer manage without extensive, computer-based methods for predicting the service life. This applies in particular to the component represented by the cylinder head, since here both the level and the gradients of the thermal and mechanical loads may be especially high locally. Super-imposed on the residual stresses deriving from the casting process and the heat treatment and the stresses due to mechanical inputs, such as those caused by bolting and pre-stressing forces, are the stresses resulting from the thermo-mechanical, cyclical operating loads. These are thermal stresses generated by temperature gradients and cyclical mechanical stresses due to gas and oscillation forces.

The calculation of the low-frequency fatigue processes (low cycle fatigue—LCF) simulates the expansion processes due to component heating and cooling and the localized plasticization partially resulting from this, and their effect over the number of cold-hot cycles. The aluminum material mainly used for the cylinder head is ductile, that is to say tough-plastic and the localized plasticization occurring may be cyclically self-healing or destructive, depending on the degree of local mean stress and constraints on expansion. Phenomena with a frequency of less than 10000 cycles are regarded as low-frequency phenomena. The calculation of the high-frequency fatigue processes (high cycle fatigue—HCF) simulates the additional, high-frequency alternating cyclic load in the operation of the engine due to gas forces and the excitation of oscillations, for example by the turbocharger and the exhaust module. As boundary conditions for the calculation, all specific material characteristics of the alloy must be available, taking into account any proposed heat treatment.

For the fatigue calculation the cylinder head should be reproduced in its installed environment, and for the modeling, the complete assembly, comprising cylinder head, cylinder block, cylinder bolts, cylinder gasket and the turbocharger connection to the exhaust system, should be taken into account.

For evaluating the simulations a local safety factor is calculated, which represents a composite variable obtained from the local stress mean values and amplitudes.

In the case cited both the HCF and the LCF simulations showed safety factors of more than three throughout the entire area of the integral manifold and only showed higher but non-critical stresses in the area of the cylinder head bolting.

### 2 System Effects/Advantages

### 2.1 System Costs

Downsizing with the aid of turbo technology, and additional, pending down-speeding, signify a modified load collective for the spark-ignition engine, that is to say the proportional time spent in the higher and high load range will be significantly greater. In order to exploit the CO₂-potential to the fullest here, it is necessary to minimize the need for enrichment on heat safeguard grounds at high loads. On this assumption it will be possible to use only high-temperature resistant materials (up to 1050° C.) and thereby high-grade and significantly more expensive materials. At present austenitic cast steel with a nickel content of up to 37% is often used for both components, the exhaust manifold and the turbine. The world market price for nickel has quadrupled in the last year and currently stands at approximately 40 USD/kg. Given an average weight of 3 to 4 kg for the external cast manifold for the in-line four-cylinder engines, the system cost advantage is already obvious on the basis of material costs alone. Added to this is the difficult and expensive machining of cast steel.

As opposed to this, the additional costs for the cylinder head and any necessary expansion of the vehicle radiator are only relatively small (see Table 1). When it comes to a downsizing of spark-ignition engine architecture, the next largest radiator assemblies are also generally available for the vehicle, for example due to the existing diesel units in the same vehicle or fundamentally more high-performance powertrains. Here the radiator generally has the same overall dimension, except for a greater depth (see also section 2.3, warm-up behavior).

The possible savings are summarized in the following Table:

TABLE 1
Example of potential cost saving from use of an integral
exhaust manifold according to the invention

| | Costs conventional |
|---|---|
| | solution = 100% |
| | (manifold |
| Components I4 turbo spark-ignition | with attachments) |
| Case 1: 4 in 1 cast steel manifold (35% nickel) | −95% |
| Smaller heat shield/steel gasket, fewer bolts | −5% |
| and nuts | |
| Cylinder head | +5% |
| Next radiator/fan size (if needed) | +15% |
| Case 2: 4 in 1 high-temperature resistant sheet- | −40% |
| metal manifold | |
| Case 1: Cost saving vs. cast steel manifold to | −80% |
| withstand 1050° C. | |
| Case 2: Cost saving vs. sheet-metal manifold | −40% |
| (if fit for series production) | |
| Additional potential: saving on auxiliary | (−60%) |
| electrical heating 1 KW | |

### Catalytic Converter Start-Up Time/Emissions

Comparison of the two systems in respect to the wall surface of the exhaust valve seat to upstream of the turbine or upstream of the catalytic converter shows a distinct difference: in the in-line four-cylinder engine constructed, the difference upstream of the turbine was approximately 30% (FIG. 7a, b) with yet further potential for reduction for the integral system (see also FIG. 1).

The dominant factor for the catalytic converter start-up (rapid attainment of the working temperature of approximately 350° C. on the catalytic converter surface) is the exhaust-side wall surface up to the catalytic converter (cf. FIG. 8). Here in the relevant catalytic converter heating time window up to approximately 30 seconds after cold-starting it makes only a negligible difference whether this surface is water-cooled or air-cooled.

As can be seen from FIG. 8, the invention achieves two effects compared to the state of the art: firstly, a reduction of the surfaces by approximately 30%, which is relevant for the cold-starting performance and the engine response in load cycles. Secondly, the water-cooled surfaces are increased by approximately 50%, which is advantageous at high engine loads.

The measurement of the two systems carried out on the test bench on the same core engine, alternately operated with a different cylinder head each time and the same turbine and same turbine position, revealed a shortening of the catalytic converter start-up time by 20%. The advantage is therefore the potential for reducing cold-starting emissions, shortening the necessary catalytic converter heating phase and hence improved fuel consumption with an integral manifold.

Due to the reduced overall wall surface, a significantly increased temperature upstream of the turbine was apparent in the first few minutes after cold-starting (FIG. 9). As the engine warms up further, whilst the wall temperatures of the water-cooled areas remain significantly cooler than the primarily air-cooled areas of the conventional system, the temperatures upstream of the turbine come into line with one another. Finally with the engine fully warmed up and under higher load, the temperature upstream of the turbine in the integral manifold system becomes even lower and can be used for the full stoichiometric operation Lambda 1 in all load ranges (cf. FIG. 8). The enrichment in the high load range conventionally prevents component overheating (turbine and manifold). For the exposed areas this is a parameter which can be optimized through the designing of the areas involved. The boundary conditions here are the maximum input into the coolant and the time taken for the torque response in the event of a load increase.

### 2.2 Fuel Consumption

Integrating the exhaust manifold into the cylinder head brings a significant improvement in fuel consumption after cold-starting and in operation.

During the warm-up phase up to approximately 10 minutes after cold-starting, the reduced catalytic converter heating time (heating time with additional fuel) and the more rapid warming of the coolant and hence the influence on engine friction contribute to fuel-saving. In the New European Driving Cycle (NEDC) a saving of 1-2% results (depending on the area ratios, as shown scaled by way of example in FIG. 8).

In operating ranges close to full load and at full load an advantage in fuel consumption of approximately 10% to 15% results, depending on the material selected and the temperature specification of the turbine housing. At high loads the conventional system has to be cooled by enrichment, so as not to exceed a component temperature of 1050° C., for example. The system constructed and designed for optimum cooling is shown in the comparison in FIG. 10 and can also be operated at the full load at Lambda 1. Here it was possible to reduce the specific fuel consumption from 285 g/KWh to 260 g/KWh.

With the still increasing trend towards downsizing and additionally towards down-speeding the time spent in the range close to full load will increase significantly in the driving profile. The system thereby makes a significant contribution to reductions in CO₂ and to the actual fuel consumption relevant to the customer.

### 2.3 Warm-Up Behavior

As already discussed in section 2.1, the integration of the exhaust manifold into the cylinder head increases the heat input into the structure and hence also into the coolant by up to 20%. FIG. 11 illustrates the influence of the integral exhaust-flow system on the coolant heat flow to be dissipated in a partial load operating range.

Also in the cold-starting phase relevant to the NEDC, however, the heat input rises, as shown in FIG. 12. In quantifying the heat flow with the aid of the first law of thermodynamics it is absolutely essential here also to take account of the variation in the internal energy of the water jacket:

$$\begin{matrix}\frac{d U}{d t} = {m}_{waterjacket} \cdot {c}_{cool} \cdot \frac{{T}_{cool - out}}{d t} \\ = \dot{Q} - \dot{m} \cdot {c}_{cool} \cdot ( {T}_{cool - out} - {T}_{cool - in} )\end{matrix}$$

Utilizing the exhaust gas heat increases the heat input into the coolant by approximately 25% before reaching the operating temperature. This effect is of considerable help in reducing the level of friction and thereby also the fuel consumption. For specific markets additional heating measures can moreover be replaced by similar power potential such as electrical PTC elements, for example, or a modified engine management, thereby further reducing the costs and the fuel consumption.

### 2.4 System Weight

Initial prototypes constructed for the in-line, four-cylinder engine saved approximately 3 kg on the overall weight of the engine compared to the cast-steel exhaust manifold. Compared to a high temperature-resistant exhaust manifold made of sheet metal for turbo applications, the result showed a further weight advantage of just under 1 kg for the engine system.

### 2.5 NVH

The direct flange-mounting of the turbocharger on the cylinder head reduces the susceptibility to boom noises, caused by low-frequency structural vibrations of the exhaust manifold in conventional designs. In addition, in downsizing units the side dominating the radiated noise is generally the exhaust side. Use of the integral manifold reduces the noise-radiating surface, so that a reduction of the noise level is likewise to be expected on the exhaust side.

### 2.6 Complexity/Assembly

Besides doing away with the conventional exhaust manifold, a further advantage of the integral design lies in the significant reduction in the number and/or the size of other parts.

Depending on the number of cylinders and the method of flange-mounting, it is possible to dispense with larger numbers of high temperature-resistant stay bolts and the associated nuts. Not only does this have a positive impact on the cost of parts, it also affords distinct advantages in logistics, assembly and servicing.

The absence of the associated tapped holes in the cylinder head furthermore saves cycle time in modern CNC production.

The exhaust gasket for the cylinder head, which now has only to seal one single gas outlet, is distinctly smaller and hence also less expensive.

As a rule, conventional exhaust manifolds of supercharged engines have to be equipped with large, costly heat shields, in order to protect their surroundings from an excessive heat input. These shields can now be dispensed with in the area of the integral manifold, since the latter, due to the cooling and thermal connection to the cylinder head, does not radiate any more heat than the conventional cylinder head. This contributes further towards reductions in the costs, complexity and overall space required. Mention must also be made of the reduced heat input into the engine compartment, which is more advantageous as a result of this construction and which is capable of reducing the demands placed on plastic parts, for example.

### 2.7 Performance

On the test bench the in-line, four-cylinder engine constructed with integral exhaust manifold showed the same torque and power profiles as the standard version, and the same lower speed on first reaching full torque.

The reduced exhaust gas temperature upstream of the turbine with the engine at operating temperature and in stationary operation, and the modified enthalpy upstream of the turbine when in this state, is compensated for or is neutralized in the event of a load increment by the significant reduction in surfaces and volume upstream of the turbine. As in the situation after cold-starting, the temperature upstream of the turbine is then, if anything, only slightly lower.

A timed measurement of the engine response following a load increment (time to full torque, T10%-T90% in FIG. 13) compared to the standard gave the same times to reach the full torque for both configurations constructed according to FIG. 1.

### Heat Flow Balance

FIG. 16 displays the local distribution of the heat transfer coefficient (HTC) for an exemplary embodiment of an integral exhaust manifold in a false-color or grey scale representation. As can be seen, the heat transfer coefficient reaches its highest values in the order of 500 W/m²K, particularly in the area where the passages unite to form a common exhaust line.

On the basis of the exhaust manifold represented in FIG. 16, as compared to a conventional exhaust manifold (that is to say one not entirely integrated into the cylinder head), the result for the integral exhaust manifold is a total water-cooled area of 565 cm², whereas a conventional exhaust manifold for an engine having largely the same characteristics (number of cylinders, rated power output), due to the exhaust paths situated partially outside the cylinder head, would have a total area for the water-cooled areas of 377 cm² (not shown); the difference in area is therefore 188 cm². Furthermore, in the case of the exhaust manifold configuration shown in FIG. 16 running at full load (5500 min⁻¹) the result, compared to a conventional exhaust manifold, is an increased energy input into the coolant of ΔP=13 kW (at 80% load it is still 10.5 kW). In operation at λ=0.9 and at full load (5500 min⁻¹) the result according to FIG. 10 (the measured values of which relate to the integral exhaust manifold shown in FIG. 16) is a further reduction in the outlet-side exhaust gas temperature—again compared to the conventional exhaust manifold—of ΔT=71 K. Forming the quotient from the temperature reduction per additional water-cooled area of 71 K/188 cm² thus gives a value of approximately 2.6 cm²/ΔK, that is to say for a desired temperature reduction by one K approximately 2.6 cm² of additional water-cooled area is required.

### 3 Prospects/Summary Findings

The analysis of the concept forming the basis of the present invention clearly showed that the integration of the exhaust manifold afforded a distinct “win-win” situation.

Whilst at the same time affording a considerable improvement in characteristic features, such integration represents a considerable potential for cost reduction. In this respect it is capable of making a considerable contribution towards future, attractive downsizing concepts for large-volume, mass production.

1. An engine arrangement with an internal combustion engine, which comprises a cylinder block having at least two cylinders, each cylinder comprising at least one exhaust port selectively closeable by an exhaust valve for removing exhaust gases, and the exhaust gases are led through exhaust lines, which unite inside a cylinder head at a junction to form one overall exhaust line, exhaust paths provided in the cylinder head being liquid-cooled by coolant passages provided in proximity to these exhaust paths, and an overall exhaust line outside the cylinder head merging into a first exhaust-flow device, wherein
a ratio of the total area of internal walls of the liquid-cooled exhaust gas paths in the cylinder head, measured from the exhaust ports to an outlet of the overall exhaust line from the cylinder head, is more than 50% of the total area of the internal walls of the exhaust paths, measured from the exhaust ports to a reference element of the first exhaust-flow device outside the cylinder head.

2. The engine arrangement as claimed in claim 1, wherein
the first exhaust-flow device is embodied as an exhaust-driven turbocharger, and the reference element is a starting area of a spiral housing (120) of a turbine (200) of the turbocharger.

3. The engine arrangement as claimed in claim 1, wherein
the first exhaust-flow device is embodied as an exhaust emission control device, and the reference element is a start of an exhaust emission control substrate on an engine side.

4. The engine arrangement as claimed claim 1, wherein
an exhaust heat dissipation capacity of liquid cooling in the cylinder head is designed in such a way that within all engine operating conditions it is possible to limit a temperature of the exhaust gas at the outlet of the overall exhaust line from the cylinder head to a predefined temperature value, so that downstream devices do not have to be of such temperature-resistant design and/or so that enrichments of fuel mixtures as a means of reducing the exhaust gas temperature in high load ranges can be dispensed with and an operation with an air-fuel ratio of λ=1.0±10% can be ensured even in the high-load ranges, a total design area of liquid-cooled internal walls of the exhaust paths being so small that a rapid start-up of an exhaust gas treatment arrangement is achieved during cold-starting of the internal combustion engine.

5. The engine arrangement as claimed in claim 1, wherein
liquid cooling of the exhaust paths in the cylinder head is designed in such a way that a temperature of the walls of the exhaust paths in the cylinder head under stationary full-load conditions does not exceed a limit of 250° C. without any need for enrichment of a fuel mixture in order to meet this limit.

6. The engine arrangement as claimed in claim 1, wherein
coolant passages, which enclose the full circumference of the overall exhaust line between the junction and the outlet of the overall exhaust line from the cylinder head, are provided in the cylinder head.

7. The engine arrangement as claimed in claim 1, wherein
the overall exhaust line between its outlet from the cylinder head and the reference element of the first exhaust-flow device is liquid-cooled in its entirety or in partial areas thereof.

8. The engine arrangement as claimed in claim 1, wherein
the first exhaust-flow device is liquid-cooled in its entirety or in partial areas thereof.

9. The engine arrangement as claimed in claim 1, wherein
the overall exhaust line between its outlet from the cylinder head and the reference element of the first exhaust-flow device is substantially air-cooled.

10. The engine arrangement as claimed in claim 1, wherein
the first exhaust-flow device which is in the exhaust path directly adjoins the cylinder head.

11. The engine arrangement as claimed in claim 1, wherein
the total area of the internal walls of the liquid-cooled exhaust paths in the cylinder head in a four-cylinder spark-ignition engine having two exhaust ports per cylinder and a rated power output of at least 100 kW with a mean diameter of the exhaust paths in the range from 25 to 30 mm, is less than 70.000 mm².

12. The engine arrangement as in claim 1, wherein
the walls of the liquid-cooled exhaust paths ensure a heat flow of at least 50 W/cm² under full-load conditions.

13. An internal combustion engine, which comprises a cylinder block having at least two cylinders, each cylinder comprising at least one exhaust port selectively closeable by an exhaust valve for removing exhaust gases, and the exhaust gases are led through exhaust lines, which unite inside a cylinder head to form one overall exhaust line, exhaust paths provided in the cylinder head being liquid-cooled by coolant passages provided in proximity to these exhaust paths, wherein
liquid cooling of the exhaust paths in the cylinder head is designed in such a way that under stationary full-load conditions an exhaust gas temperature at an outlet from the cylinder head does not exceed a predefined limit of 1050° C., 970° C., or 850° C., without any need for enrichment of a fuel mixture in order to meet this limit.

14. An internal combustion engine, comprising:
a cylinder head
a cylinder block having at least two cylinders, each cylinder comprising at least one exhaust port selectively closeable by an exhaust valve for removing exhaust gases, exhaust gases through exhaust lines, which unite inside the cylinder head to form one overall exhaust line, where exhaust paths provided in the cylinder head are liquid-cooled by coolant passages provided in proximity to these exhaust paths, and wherein
liquid cooling of the exhaust paths is designed in such a way that in stationary partial and full-load operation of the internal combustion engine, which is above 80% of a rated power output and in excess of an engine speed of 4400 min⁻¹ with a stoichiometric mixture, a ratio of total heat output given off to coolant by the internal combustion engine as a proportion of delivered mechanical power output is not less than 50%.
